(19) United States
(12) Patent Application Publication
(10) Pub. No.: US 2009/0169738 A1
(43) Pub. Date: Jul. 2, 2009

(54) Method for rapid manufacture of carbon-based tooling for melt infiltration

(75) Inventors: Paul Edward Gray, North East, MD (US); Roger Lee Ken Matsumoto, Newark, DE (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/003,637

(22) Filed: Dec. 28, 2007

(51) Int. Cl. C23C 18/02; B29C 39/00

(52) U.S. Cl. 427/227; 264/29.1

(57) ABSTRACT

A method of manufacturing a carbon-based tooling for use as the support during melt infiltration processing of a prepreg preform used, for example, to manufacture turbine engine components, comprising forming an admixture of chopped carbon fibers, graphite powder and a high durometer thermosetting organic resin, applying a potion of the admixture at room temperature onto the surface of an aluminum die, initially curing the admixture as applied to the aluminum die for a period of 3-5 hours at a temperature of between about 100 and 200 degrees C., removing the carbon-based tooling from the aluminum die and carbonizing the tooling by heating the initially cured tooling to a temperature of about 750 degrees C for a period of about 40 hours. The carbon-based tooling according to the invention retains its shape-maintaining function during the high temperature melt infiltration and does not require subsequent machining after formation, thereby providing a rapid, cost-effective method for creating a carbon-based support tool that remains stable at high temperatures.

The present invention relates to the fabrication of composite tooling articles and, more particularly, to a method for fabricating a carbon-based tool that is dimensionally stable at high temperatures and can be used to support prepreg preforms during melt infiltration (silicon infiltration processing) of the preform at elevated temperatures, i.e., near or above 1,000 degrees C. Once formed, initially cured and heat treated according to the process described herein, the carbon-based support tool provides an important shape-maintaining function during melt infiltration at the sustained high temperatures necessary to manufacture ceramic matrix composite (“CMC”) preforms. That is, the support tool effectively prevents the preform from undergoing distortion during melt infiltration, thereby avoiding the need for machining or other post-treatment steps to correct dimensional changes to the CMC preform that otherwise might occur during conventional high temperature melt infiltration operations.

### BACKGROUND OF THE INVENTION

In recent years, silicon carbide-based ceramic matrix composite (“CMC”) materials have been used with increasing frequency in the manufacture of component parts for gas turbine engines. The known methods for using CMC materials typically involve forming the preform into a desired shape followed by various heat treatment stages and melt-infiltration processing at high temperature using a silicon alloy infiltrant.

The process described herein provides a rapid, cost-effective method for creating a composite, carbon-based support tool that remains dimensionally stable at high temperatures and offers distinct advantages over prior art techniques used to manufacture CMC preforms. Typical applications of the method include the formation of support tools for preforms used to manufacture turbine parts or jet engine components such as, for example, jet engine nozzle flaps, turbine blades, turbine vanes and the like.

A significant problem can occur in the manufacture of CMC preforms during melt infiltration when the process takes place at high temperature without adequate support for the preform. Given the elevated temperatures and extended time periods necessary for melt infiltration, performs without adequate structural support have a tendency to warp and/or shrink to some degree, typically due to the loss of volatile components during heating, such as the resins used to form the preform initially. The tooling industry is well aware of the potential for warpage and or dimensional distortion during heating and MI. However, predicting the amount and location of dimensional changes during heat treatment and melt infiltration is a difficult and often unreliable process. In addition, support structures used in the past for MI processes are expensive and time consuming to create. The problems encountered by persons skilled in the carbon-based tool art, particularly the problem of avoiding shrinkage and/or warping of the preform during MI, can be seen in various processes described in the prior art.

The patent to Chiang et al, U.S. Pat. No. 5,509,555, discloses the production of silicon carbide composite bodies through the use of a silicon alloy infiltrant where the preform to be infiltrated consists of carbon or carbon combined with at least one other material such as a metal or an intermetallic compound. Typically, end products formed from the '555 process require at least some finishing and/or machining following heat treatment.

U.S. Pat. No. 5,730,915 to Cornie describes a method for producing pressure infiltration tooling by blending a sol-gel ceramic precursor with a refractory powder to form a moldable material, shaping the moldable material to form a green tooling body and then heating the green tooling body to convert the sol-gel ceramic precursor into a ceramic to form the finished casting tooling. The sol-gel precursor can be an alumina, zirconia or silica sol-gel precursor and the refractory powder can be a powder such as silicon carbide. The volume fractions of sol-gel ceramic precursor and refractory powder can change significantly during heat treatment (thereby effecting product dimensions), depending on the desired thermal conductivity, coefficient of thermal expansion and density needed to fulfill the demands of the particular casting process in which the casting tooling will be used.

U.S. Pat. No. 4,546,674 describes a method of providing a support tool in the form of reinforcing material compound comprising a resin that cures in the presence of a hardener to form a solid, thermosetting plastic, a filler material (such as calcium carbonate), a thickening agent (silica gel) and carbon fibers. The '674 method cannot be used in the higher temperature curing applications necessary for CMC preforms due to undesirable reactions of the filler material with the resin and likely degradation of the physical properties of the end product.

Commonly-owned U.S. Pat. Nos. 5,015,540, 5,330,854, 5,336,350 and 6,258,737 involve the production of silicon carbide matrix composites containing fibrous material infiltrated with molten silicon (generally known as the “Silcomp process”). The Silcomp process for making silicon-silicon carbide composite uses coarse carbon and silicon carbide powders as filler materials in the slurry composition coated on the fibers or in the preform itself. The coarse powders do not completely react during the molten silicon infiltration to convert all of the available carbon to silicon carbide, resulting in a high residual carbon content in the matrix (about 10-20 volume percent silicon).

Thus, a need exists for a carbon-based support tool that can be used effectively for melt-infiltration processing (e.g., silicon infiltration) in the manufacture of CMC preforms that is quick and easy to manufacture and remains dimensionally stable at high temperatures, thereby precluding to the extent possible any significant dimensionally changes to preform during MI, particularly at temperatures at or above 1000° C. That is, a need remains for a thermally stable carbon-based tool that accurately replicates and adequately supports the prepreg during melt infiltration.

### BRIEF DESCRIPTION OF THE INVENTION

The Carbon-based tooling support according to the present invention can be prepared using various tool forming techniques. Typically, the compositions are charged into a forming die, e.g., an aluminum die, having the shape of the component (such as a turbine blade) to be produced. The composition in the forming die is then initially cured and heated, allowed to cool and thereafter treated at much higher temperature (for example, in a box furnace) to achieve final carbonization. In one embodiment, tooling composition comprises a mixture of high-char, thermosetting organic resin, chopped carbon fibers and graphite powder.

The tool can also be formed by applying the carbon-based composition directly to another tooled surface. The molded “splash” is then cured (initially setting the resin) at a temperature between about 200 and 300 degrees C. and thereafter carbonized at high temperature, i.e., typically above 700 degrees C. Significantly, as noted above, the higher temperature carbonizing step occurs without any appreciable shrinkage of the tooling itself. The support tool also maintains its dimensional stability during subsequent MI processing.

An alternative process according to the invention includes the step of initially creating a hard plastic replica of an engine component using a molding composition, such as silicon rubber or epoxy. The hardened plastic replica is then used to form the carbon-based tool according to the invention by applying the compositions as described above and then heat-treating (carbonizing) the applied material.

Those skilled in the art will appreciate that the invention is generally applicable to a variety of different CMC fabrication processes using melt infiltration. CMC preforms typically consist of silicon carbide fibers and boron nitride, with SiC fiber coatings infiltrated into the preform, resulting in a preform with a rigid and defined shape. The melt infiltration of silicon into the preform (resulting in matrix densification), normally occurs at temperatures above 1000° C. Although the present invention has particular application in the formation of aviation parts, such as an jet engine nozzle flaps, the same method and tooling compositions could be used in other melt-infiltration manufacturing operations.

### BRIEF DESCRIPTION OF THE DRAWINGS

FIG. 1 is a simplified block flow diagram depicting exemplary process steps for manufacturing the carbon-based tooling for use in high temperature, melt infiltration processes according to the invention;

FIG. 2 is an isometric view of an exemplary portion of the carbon-based tooling in accordance with the invention after formation but prior to the tooling undergoing heat treatment;

FIG. 3 shows the carbon-based tooling according to the invention as shown in FIG. 2 following heat treatment with an exemplary prepreg preform positioned on the top surface of the tooling prior to undergoing melt infiltration; and

FIG. 4 shows the carbon-based tooling of FIG. 3 after the surface of the prepreg preform has been treated with a melt-infiltration coating as described below.

### DETAILED DESCRIPTION OF THE INVENTION

As noted above, the present invention provides a new form of carbon-based tooling for use in melt-infiltration (e.g., silicon-infiltration) of CMC prepreg preforms. The invention provides a thermally stable, high temperature tool capable of providing a shape-maintaining function for a prepreg preform subjected to MI processing using, for example, a silicon boron nitride composition applied to the preform surface. A unique mixture of high char, thermosetting organic resin, chopped carbon fibers and graphite powder are molded by applying the composition directly against a tooled surface or a plastic model of the desired shape. The resulting molded “splash” is cured and then carbonized through heat treatment for immediate use as the carbon-based support tool for melt infiltration processing without any need for custom tooling or post treatment. Surprisingly, the porous nature of the carbon support tool according to the invention also helps to dissipate gases formed within the preform and/or the silicon coating during melt infiltration, i.e., an additional benefit not achieved by the prior art.

The present carbon-based tooling support also exhibits significantly lower, i.e., almost negligible, shrinkage as compared to prior art support structures during curing and carbonization. Presumably, the virtual absence of shrinkage of the tool during formation is due in part to the inclusion of a substantial fraction of stable polyacrylonitrile (PAN) carbon fibers as one component. The invention thus offers a distinct advantage over such systems because no subsequent processing of the tooling is required after curing or before it can be used in melt infiltration. Thus, the carbon-based tooling according to the invention can be produced in final form for use in MI processing in a much shorter period of time than custom tooling (which typically require various post-curing operations to form the tool before use).

In addition, the process according to the invention allows for a much faster, very predictable and more economical carbon-based support tool. The use of high-char furanic-based resin according to the invention has also been found to increase the strength of the finished support tool, making impregnation of the tool or other treatments following carbonization unnecessary.

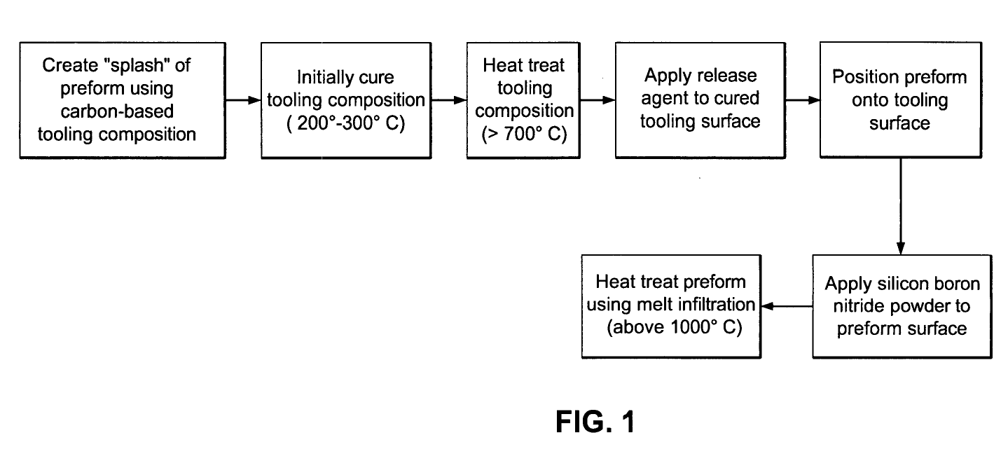

FIG. 1 of the drawings a simplified block flow diagram depicting exemplary process steps for manufacturing the carbon-based tooling for use in melt infiltration processes according to the invention. Initially, a “splash” comprising a reverse image of the prepreg preform component to be melt infiltrated is created by applying the carbon-based tool composition according to the invention directly to the component part itself or by charging a forming die with the composition mixture. The tooling composition is allowed to cure initially at a relatively low temperature, i.e., below 200 degrees C. (as compared to the high heat treatment temperature used for the melt infiltration). Alternatively, the tooling can be formed by initially creating a hardened plastic replica of the part (such as a turbine blade) comprised of a thermoplastic material that in turn is “splashed” with the carbon-based tooling composition and then cured.

After the support tool is formed and initially cured, it is subjected to heat treatment at a temperature above 700 degrees C. up to about 900 degrees C. for a period of between 35 and 40 hours. As noted above, the heat treatment at that temperature and duration does not result in any appreciable shrinkage of the tooling. Optionally, a second heat treatment can be used at approximately the same high curing temperature but for a shorter period (3-5 hours) in order to remove any trace volatile species resident in the already once-cured tooling composition.

Following carbonization and cooling, the tooling support is ready for use in a melt infiltration processing of a preform. As FIG. 1 indicates, the preform is positioned directly onto the support surface, typically under a uniformly applied pressure to the top surface, e.g., about 10-15 psi. This evenly distributed load on the surface can be supplied by, for example, a layer of zirconium oxide balls applied after the melt infiltration powder has been applied to the top surface of the preform. The entire structure (including the carbon-based support itself) is then subjected to melt infiltration at high temperature, i.e., above 1,000 degrees C.

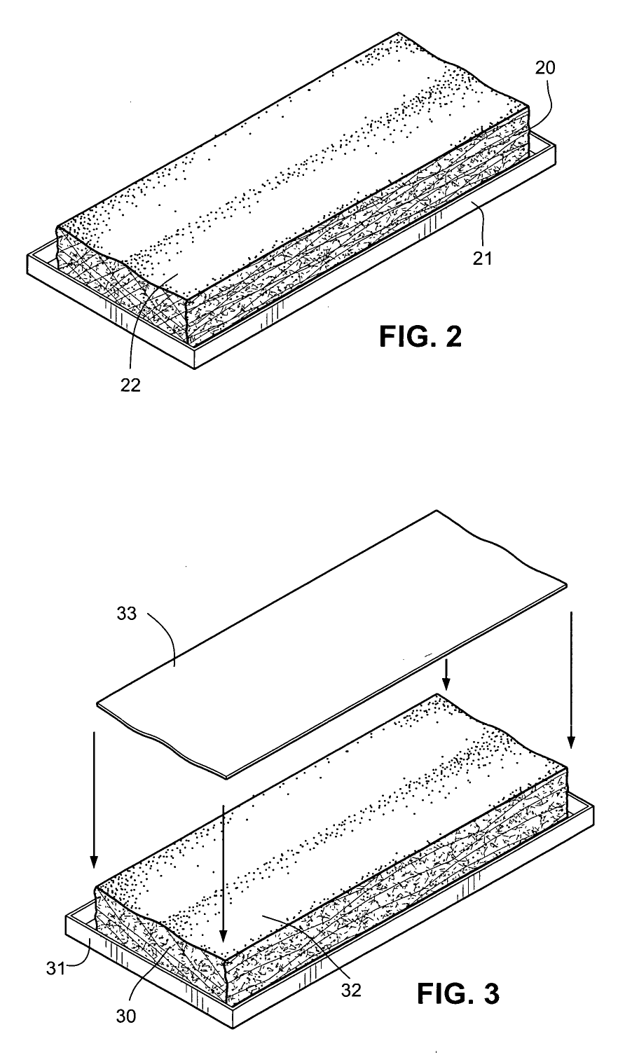

FIG. 2 of the drawings is an isometric view of an exemplary portion of the carbon-based tooling according to the invention after formation and initial curing but prior to the tooling undergoing final heat treatment. Support 20 includes a top surface configuration 22 that is a mirror image of the preform that will rest on the support surface during melt infiltration. The carbon based tooling itself is supported by base plate 21.

FIG. 3 shows carbon-based tooling 30 as depicted in FIG. 2 following heat treatment with an exemplary prepreg preform 33 positioned on the top surface 32 of the tooling prior to undergoing any surface treatment. The entire structure is supported during melt infiltration by base plate 31.

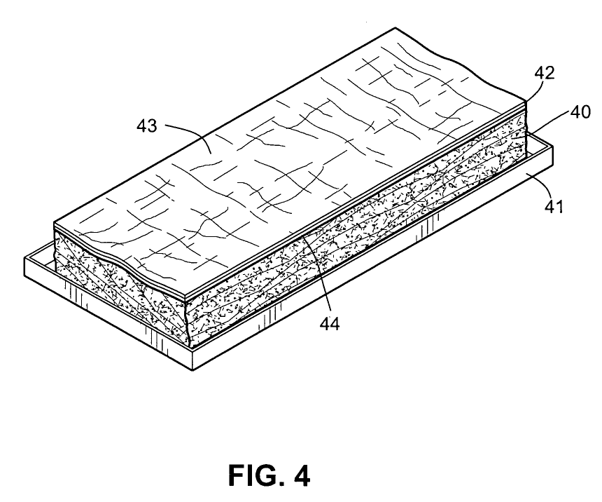

FIG. 4 shows the carbon-based tooling depicted in FIGS. 2 and 3 after the surface of the preform has been treated with a boron silicon coating and the entire structure melt infiltrated at high temperature as described above and the examples below. Nominally, the top surface of the preform remains under a uniform load during the entire melt infiltration process.

### EXAMPLE 1

A mixture of 1316 grams of ¼″ Fortafil® PAN carbon fibers, 1034 grams 50/50% pitch-furaldehyde resin and 104 grams of p-tolulenesulfonic acid (catalyst) were mixed in a Hobart 5 gallon commercial mixer. The material was placed into a die in the shape of a turbine blade made from a high durometer silicone resin. The chopped fiber mix was then charged into the die, followed by affixing the top plate. The assembly was then loaded into a heated platen press. A force of about 15 psi was applied to the top plate and the platen temperature slowly raised to 160° C. over three hours. The molded tool was allowed to cool in the press under pressure. The tool was removed from the die and loaded into a nitrogen-purged box furnace for final carbonization, with the temperature of the furnace raised to 750° C. over a period of 40 hours. After cooling, the molded tool was removed and re-heated in a graphite element furnace to 1500° C. over a period of 5 hours to remove any traces of volatile species. The tool was then ready for use as a melt infiltration forming die.

### EXAMPLE 2

A mixture of 1116 grams of ¼″ Fortafil® PAN carbon fibers, 200 grams Lonza graphite powder, 1034 grams 50/50% pitch-furaldehyde resin and 104 grams of p-tolulenesulfonic acid (catalyst) were mixed in a Hobart 5 gallon commercial mixer. The mixture was then loaded into an aluminum die in the shape of a turbine engine axisymmetric nozzle seal. The aluminum die surface was coated with an approximate 1 mil layer of Teflon film. The mixture in the die was heated in a platen press, carbonized and thermally stabilized in a graphite element furnace as described above in example 1. A nozzle seal preform was melt infiltrated against the chopped fiber tool and found to be free from any warpage during the siliconization process. During melt infiltration, a uniform distributed load (zirconium balls) was applied to the surface of the preform in order to ensure direct, uniform contact with the support tooling.

Although the above examples relate to turbine engine nozzle components, the same carbon-based support tooling compositions and technique could be used for a wide variety of other components (such as jet engine nozzle flaps, steam turbine components, etc.) intended for use in high temperature environments. In addition, the amount of silicon boron nitride powder will depend on the thickness, surface area and total weight of the preform to be melt-infiltrated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of manufacturing a carbon based tooling for use as the support during melt infiltration processing of a prepreg preform, comprising
forming an admixture of chopped carbon fibers, graphite powder and a high char thermosetting organic resin,
charging a portion of said admixture at room temperature into a forming die;
initially curing said admixture as charged into said forming die for a period of 3 5 hours at a temperature of between about 100 and 200 degrees C.;
removing said carbon based tooling from said forming die following said initially curing step; and
carbonizing said tooling by heating said initially cured tooling to a temperature of about 750 degrees C. for a period of about 40 hours.

2. A method according to claim 1, wherein said carbon fibers are approximately ¼ inch in length and comprise about 45% by weight of said admixture.

3. A method according to claim 1, wherein said thermosetting organic resin comprises about 50% by weight pitch furaldehye resin.

4. A method according to claim 1, wherein said step of initially curing said admixture occurs at between 100 and 200 degrees C. for a period of between 3 and 5 hours.

5. A method according to claim 1, wherein said step of carbonizing said tooling takes place at a temperature above 750 degrees C. for a period of between 30 and 40 hours.

6. A method according to claim 1, further comprising the step of adding about 5 percent by weight p toluene sulfonic acid catalyst during said step of forming said admixture.

7. A method for performing melt infiltration processing on a prepreg preform, comprising the steps of
forming a carbon based support tooling for said prepreg preform, said tooling having a configured top surface formed from an admixture of chopped carbon fibers, graphite powder and a high durometer thermosetting organic resin and said support tooling having a top surface configuration in precise registry with the bottom surface of said prepreg preform;
initially curing said carbon based tooling;
carbonizing said carbon based tooling under high temperature;
positioning said preform prepreg onto said configured top surface of said carbon based tooling, wherein the bottom surface of said prepreg preform is in registry with the top surface of said carbon based tooling;
applying an amount of silicon powder to the top surface of said preform sufficient to convert substantially all of the available carbon in said prepreg preform during melt infiltration;
applying pressure in the form of a distributed load uniformly onto the surface of said carbon based tooling and said prepreg preform; and
heating said carbon based tooling and said prepreg preform to cause melt infiltration of said silicon powder into said prepreg preform at a temperature sufficient to cause matrix densification of said preform.

8. A method according to claim 7, wherein said step of heating said carbon based tooling and said preform to cause melt infiltration occurs at a temperature above about 1,000 degrees C.

9. A method according to claim 7, wherein said silicon powder comprises silicon boron nitride.

10. A method according to claim 7, wherein said step of applying a distributed load results in a substantially uniform pressure of about 15 psi being applied to the entire top surface of said prepreg preform during melt infiltration.
